(19) United States
(12) Patent Application Publication
(10) Pub. No.: US 2012/0089272 A1
(43) Pub. Date: Apr. 12, 2012

(54) Vehicle Monitoring Device Based on Use of Dashboard Indicators

(75) Inventor: Rohit Satish Kalbag, Coppell, TX (US)

(73) Assignee: Rohit Satish Kalbag, Coppell, TX (US)

(21) Appl. No.: 13/251,260

(22) Filed: Oct. 2, 2011

Related U.S. Application Data
(60) Provisional application No. 61/392,043, filed on Oct. 12, 2010.

(51) Int. Cl. G06F 7/00

(52) U.S. Cl. 701/1

(57) ABSTRACT

A vehicle monitoring device may include a set of sensors that may be mounted over indicators and analog gauges displayed on a vehicle's dashboard. The vehicle monitoring device may use these sensors to deduce the current state of the dashboard indicators and in turn generate an output signal that resembles the signal which would have been generated by the vehicle's electrical system to which the dashboard indicators are connected. Use of this vehicle monitoring device allows for easy connection of after-market vehicular safety devices such as, lane warning departure systems, to the vehicle monitoring device instead of the vehicle's electrical system.

### BACKGROUND

1. Technical Field

The present invention relates to providing alternative means to easily connect after-market equipment, such as lane departure warning systems, that need access to vehicle's electrical circuitry in order to detect the vehicle's operational state.

2. Description of Related Art

In the after-market equipment market, there are lot of products available to enhance the safety of the vehicle.

These safety devices need to be connected to the vehicle's electrical system because they need to detect the driver's intention to properly function. These devices therefore tap into the electrical system that power the vehicle's various directional indicators such as, the reverse indicator and the left and right indicators.

Due to the need to hookup these devices to the vehicle's electrical system, which varies according to the manufacturer and model of the vehicle, these systems need to be installed by professionals.

However, users may be hesitant to pay the premium labor costs for professionally installing these devices. Thus, users may not use the variety of after-market systems, even when available.

### SUMMARY

A vehicle monitoring device based on use of dashboard indicators may include a collection of sensors, a sensor monitoring system, and a vehicle circuitry emulation system.

The collection of sensors may be mounted on the dashboard of the vehicle over the indicators that need to be monitored, or the light emitted from these indicators could be conveyed to remote sensors via fiber optic strands that may be mounted over the indicators.

The sensor monitoring system may be configured to detect a change in state of the sensors and convey to the vehicle circuitry emulation system that a particular dashboard indicator has been activated or changed state.

The vehicle circuitry emulation system may be configured to generate the appropriate electrical signal, based on the current state of the dashboard indicators, corresponding to different classes of vehicle similar to what would be generated by the actual vehicle's electrical system for that class of vehicles. The vehicle accessory that would have needed to be professionally connected to the vehicle's electrical system can now be connected, by a layperson, to the vehicle circuitry emulation system instead.

These, as well as other components, steps, features, objects, benefits, and advantages, will now become clear from a review of the following detailed description of illustrative embodiments, the accompanying drawings, and the claims.

### BRIEF DESCRIPTION OF DRAWING

The drawing disclose illustrative embodiments. The drawing does not set forth all embodiments. Other embodiments may be used in addition or instead. Details which may be apparent or unnecessary may be omitted to save space or for more effective illustration. Conversely, some embodiments may be practiced without all of the details which are disclosed. When the same numeral appears in the drawing, it refers to the same or like components or steps.

FIG. 1 illustrates a vehicle monitoring device based on use of dashboard indicators.

### DETAILED DESCRIPTION OF ILLUSTRATIVE EMBODIMENTS

Illustrative embodiments are now discussed. Other embodiments may be used in addition or instead. Details which may be apparent or unnecessary may be omitted to save space or for a more effective presentation. Conversely, some embodiments may be practiced without all of the details which are disclosed.

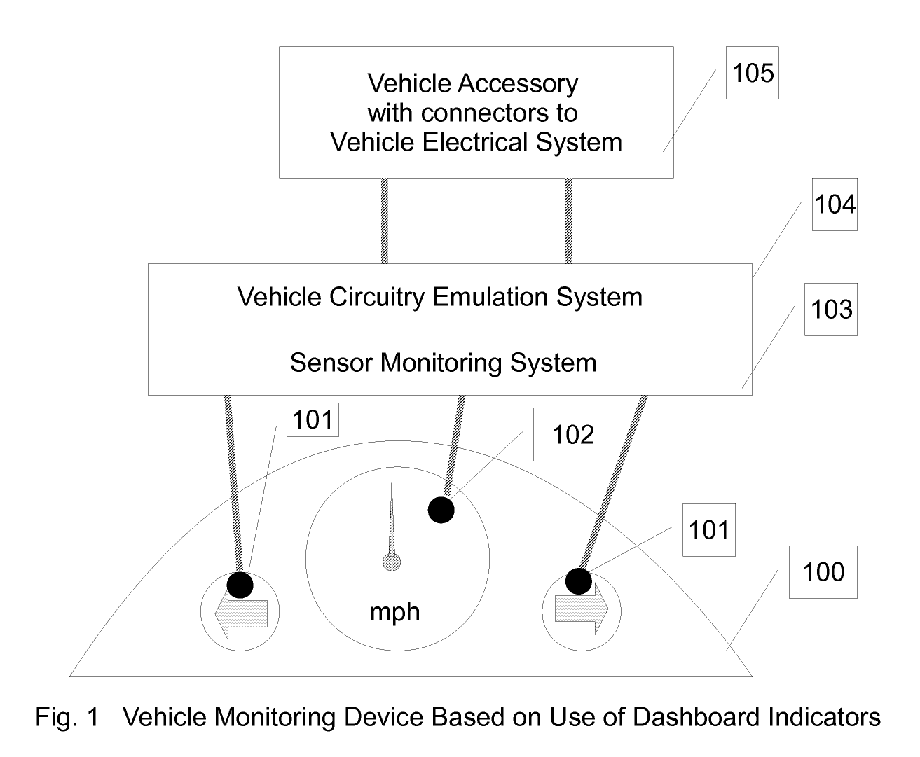

FIG. 1 illustrates a vehicle monitoring device based on use of dashboard indicators. As illustrated in FIG. 1, a vehicle monitoring device may include a set of sensors 101 and 102 attached to a vehicle's dashboard 100, a sensor monitoring system 103, a vehicle circuitry emulation system 104, and a vehicle accessory 105 that is designed to use signals from the actual vehicle's electrical circuitry to function properly.

The vehicle dashboard 100 may belong to different types of vehicles. For example, automobiles, motorcycles, or trucks. Even though these dashboards will differ greatly across different vehicles, they generally display certain indicators that are common across all vehicle dashboards. For example, left and right turn indicators, and a variety of analog gauges that display vehicle speed, fuel level, etc. For clarity and simplicity only a few indicators that could be monitored are illustrated in FIG. 1.

The sensors 101, 102 may be of different types based on the type of dashboard indicator being monitored. Sensors 101 may be of a type that is used to detect the intensity of light being emitted from the dashboard indicator. Sensor 102 may be of a type that is used to detect changes in reflected light emitted from the sensor caused by on an opaque object crossing the path of light.

The sensors 101, 102 may be mounted on the dashboard over the indicators to be monitored by a variety of means, one of which may be by use of suction cups. Attaching the sensors on the dashboard via suction cups provides the added benefit of easy repositioning of the sensors over the dashboard and easier portability of the sensors from one vehicle to another vehicle.

In a different embodiment, the actual sensors 101, 102 may be located remotely in another system and optical fibers may be used to transport the light emitted or reflected from the dashboard indicators to the sensors. The ends of the optical fibers would be attached over the dashboard indicators. These optical fibers may be mounted on the dashboard over the indicators to be monitored by a variety of means, one of which may be by use of suction cups.

The sensor monitoring system 103 may be configured to monitor the electrical or electronic signal being transmitted by the sensors 101 and 102. The sensor monitoring system may deduce the current state of the dashboard indicator being monitored based on the electrical or electronic signal transmitted by the sensors 101 and 102.

For example, the sensor monitoring system 103 may deduce whether the left or right turn indicators are blinking or not based on sensor 101. Sensor 101 may be a type of light dependent resistor in which change in resistance is caused by intensity of light. The sensor monitoring system 103 may deduce that the left or right turn indicator is not blinking when the voltage drop across the sensor 101 is high and deduce that the left or right turn indicator is ON when the voltage drop across the sensor 101 is low.

For example, The sensor monitoring system 103 may deduce whether the speed of the vehicle has passed a speed threshold based on sensor 102. Sensor 102 may be positioned on the speedometer over the desired speed threshold. Sensor 102 may be a type of retro-reflective sensor which gets turned ON when the needle is present between the sensor and reflector. The sensor monitoring system may deduce that the speed of the vehicle is over the threshold when the sensor 102 turns ON.

The sensor monitoring system 103 may have controls to fine tune the output of sensors, map sensors to indicators being monitored, and fine-tune the monitoring detection thresholds.

The sensor monitoring system 103 may have visual indicators to display the deduced state of the dashboard indicator. This may be helpful in fine tuning the monitoring system and also can serve as a replacement for the dashboard indicator being monitored if the view of the actual indicator, on the dashboard, is obstructed by the sensor.

The sensor monitoring system 103 may transmit the deduced state of the dashboard indicators to the vehicle circuitry emulation system 104.

The vehicle circuitry emulation system 104 may output an electrical signal corresponding to the one that is generated by the vehicle's internal electrical system for a particular type of vehicle for a particular type of condition that led to the current state of the dashboard indicator. The current state of the dashboard indicator is provided by the sensor monitoring system 103.

For example, the vehicle circuitry emulation system 104 may output an electrical signal of +12V for a car when the sensor monitoring system 103 detects that left-turn indicator is ON because the internal electrical system of the car uses +12 V to indicate that driver has turned ON the left-turn signal.

The vehicle circuitry emulation system 104 may have controls to configure it to output the electrical signals that are generated by a particular class of vehicles such as, trucks, automobiles, boats, motorcycles, etc.

A variety of vehicle accessories 105 such as, lane departure warning systems, that are dependent on being connected to the vehicle's electrical system to receive information that can be deduced by use of dashboard indicators may be connected to the output of the vehicle circuitry emulation system 104.

In a different embodiment, the vehicle accessory could be a part of the vehicle circuitry emulation system 104 or the sensor monitoring system 103.

The various components which have thus-far been described, such as the set of sensors 101, 102, the sensor monitoring system 103, the vehicle circuitry emulation system 104, and the vehicle accessory 105, may be implemented with electronic hardware configured to perform the functions which these components are described herein as performing in accordance with well-established technologies. Software, including an operating system and associated application programming instructions, may be included in connection with each component to facilitate their described functionality.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged, combined, and/or ordered differently.

All articles, patents, patent applications, and other publications which have been cited in this disclosure are hereby incorporated herein by reference.

The phrase “means for” when used in a claim is intended to and should be interpreted to embrace the corresponding structures and materials which have been described and their equivalents. Similarly, the phrase “step for” when used in a claim is intended to and should be interpreted to embrace the corresponding acts which have been described and their equivalents. The absence of these phrases in a claim mean that the claim is not intended to and should not be interpreted to be limited to any of the corresponding structures, materials, or acts or to their equivalents.

Nothing which has been stated or illustrated is intended or should be interpreted to cause a dedication of any component, step, feature, object, benefit, advantage, or equivalent to the public, regardless of whether it is recited in the claims.

The scope of protection is limited solely by the claims which now follow. That scope is intended and should be interpreted to be as broad as is consistent with the ordinary meaning of the language which is used in the claims when interpreted in light of this specification and the prosecution history which follows and to encompass all structural and functional equivalents.

The invention claimed is:

1. A vehicle monitoring device comprising:
a set of sensors used to detect the current condition of various indicators displayed to the vehicle's driver;
a monitoring system to detect the state of respective indicators based on monitoring of the sensors; and
an emulation system that would output the same kind of electrical or electronic signal as would have been generated by the vehicle's internal electrical or electronic circuitry, to which the indicators are connected, corresponding to the state of the indicators being monitored.

2. The vehicle monitoring device of claim 1. wherein the sensors are mounted on the vehicle's dashboard over indicators and analog instrument gauges of interest.

3. The vehicle monitoring device of claim 1. wherein sensors are used to detect illumination intensity of indicators.

4. The vehicle monitoring device of claim 1. wherein sensors are used to detect interruption of light being emitted by the sensor due to passage of needle that is present on an analog instrument gauge.

5. The vehicle monitoring device of claim 1. wherein the sensors are mounted by use of suction cups.
